(19) United States
(12) Patent Application Publication
(10) Pub. No.: US 2011/0311940 A1
(43) Pub. Date: Dec. 22, 2011

(54) APPARATUS AND METHOD FOR SIMULATING THE MOBILITY OF A TOOTH

(75) Inventors: Kurt-Jürgen Erdelt, Munchen (DE); Josef Schweiger, Bergen (DE)

(73) Assignee: LUDWIG-MAXIMILIANS-UNIVERSITAT, Munchen (DE)

(21) Appl. No.: 12/671,731

(22) PCT Filed: Aug. 1, 2008
(86) PCT No.: PCT/EP2008/006381

§ 371 Date: Aug. 19, 2011

(30) Foreign Application Priority Data
Aug. 2, 2007 (DE) 10 2007 036 149.3

(51) Int. Cl. A61C 19/04

(52) U.S. Cl. 433/72

(57) ABSTRACT

The present invention relates to an apparatus and method which makes it possible to simulate a realistic, reliable, and repeatable measurement of the mobility of a tooth and use the test results as a basis for producing and adjusting tooth prostheses. A goal is achieved by an apparatus for simulating the mobility of a tooth, comprising a bottom and a top bearing shell which are designed such that a substantially spherical zone is left open. The top bearing shell has a substantially circular cavity, through which a model of a tooth stump can be inserted. One end of the model of a tooth stump has a substantially spherical bearing zone while the other end thereof forms an elongate shank.

The present invention relates to a device and a method for simulating the mobility of a tooth.

In the natural denture of a human being the teeth are not anchored directly in the bone, but are fixed in the jaw-bone by means of the periodontium. The periodontium is composed of small blood vessels, nerves, and the collagen fibers (Sharpey's fibers). On the collagen fibers the tooth is suspended in the jaw-bone, the blood vessels supply the tooth with nutrients. The collagen fibers have an effect similar to a shock absorber. A force acting on the tooth is not transmitted directly to the jaw-bone, but is absorbed.

The mobility of the natural tooth is subjected to a very complex movement scheme that depends on a plurality of parameters. For instance, on the rate of load, the extension and the quality of the jaw-bone, the number of fibers, the dimension of the periodontal gap, the tooth morphology, etc. The natural mobility of a healthy tooth amounts to approx. 50 to 100 μm with a load of 2 N to 5 N, it is, however, also dependent on the group of teeth.

Due to the complex movement scheme there are substantial differences between a firmly embedded dental prosthesis (implant) and a normally movable tooth. The implant transmits the impacting forces directly into the jaw-bone. Thus, a force-proportionate deflection of the implant and of the jaw-bone is the result.

In the case of a healthy natural tooth first of all the collagen fibers are strained in the case of load in the so-called initial/desmodontal tooth mobility until the tooth touches the jaw-bone. After this contact the natural tooth behaves similar to the implant. The load strain curve after this bone contact is composed of the strain of the tooth and of the jaw-bone.

The initial/desmodontal tooth mobility range lies between 2 and 5 Newton. With a further increase of the load an elastic deformation of the tooth and of the jaw-bone (secondary deformation) will occur. The transition from the initial to the secondary deformation is not abrupt, but describes a smooth transition.

Due to this, the actual tooth mobility load limit ranges at approx. 5 N. The tooth mobility is of substantial importance in dentistry when a patient is supplied with a dental prosthesis. The probability of failure of the dental prosthesis and the quality depend to a large degree on the mobility of the abutment teeth. It is therefore useful when simulating the lifetime of a dental prosthesis to mount it on respectively movable supports. With such a model one would get as close as possible to real conditions in the mouth.

Previous tooth mobility models have been used to simulate the aging of the prosthetic restorations. These models, however, meet this requirement in a very restricted scope only since the tooth mobility is detected in a very insufficient manner only during the artificial aging of bridge restorations. The larger the mobility differences between the abutment teeth are, the larger is the load in the binding region of the bridge member. This usually results in a reduction of the lifetime of the dental prosthesis due to fatigue fractures.

From prior art, three different variants of simulation models for in vitro tests of tooth mobility are known:

### 1. Rigid Metal Model

A rigid model may either be cast of metal in the “lost wax” method or be manufactured by means of CAD/CAM or rapid prototyping method, respectively. This kind of simulation model, however, does not exhibit any mobility at all of the individual teeth. The test results resulting therefrom cannot easily be transferred to the clinical situation since a basic parameter for a long time success of a restoration is not taken into account.

2. Model with Metal Stumps in Plastic Block with Flexible Coating in the Root Area

This model is used at the Poliklinik für Zahnärztliche Prothetik der LMU München (Polyclinic for Prosthodontics of Ludwig Maximilian University Munich) for in vitro tests. Metal stumps are coated with a flexible layer (e.g. heat shrinkable tubing) and the stumps are altogether embedded in a plastic block of PMMA (polymethylmethacrylat). The coating may also be performed by means of a flexible varnish. This kind of models enables a tooth mobility in a certain scope. However, the scope of mobility cannot be modified, deflection curves are exhibited which do in no way concur with the physiologic tooth mobility curve. Due to the construction out of touch with reality, the test results gained with the model cannot be transferred to the clinical situation, either.

3. Model with Natural Teeth which is Coated with Polyether in the Root Area and Embedded in Plastic Blocks.

Such a model is, for instance, used by the Zahnklinik Regensburg (Dental Clinic Regensburg). Suitable intact extracted teeth are coated with a layer of polyether (Impregum, Company 3M ESPE) and subsequently cast in PMMA blocks. A substantial disadvantage of these models consists in that neither an exactly defined layer thickness of the polyether material can be achieved nor reproducible models can be produced. Every natural tooth comprises a different morphology and therefore it differs with respect to the deflection curves. A comparability with other test series is therefore not possible, either, with this model.

In the model of prior art it has therefore turned out to be a disadvantage that they do not resemble the movement profiles of natural teeth, that the degree of loosening of teeth cannot be adjusted individually, that the movement profiles are not reproducible, and that the measurements are not comparable among each other.

It is therefore an object of the present invention to provide a device and a method by which it is possible to simulate a naturalistic and reliable as well as repeatable measurement of the tooth mobility and to use these measurement results as a basis for the preparation and fitting of dental prostheses.

This object is solved by the device according to the invention with the features pursuant to claim 1, and by the method with the features pursuant to claim 8. Advantageous further developments of the present invention are indicated in claims 2 to 7 and 9.

The device according to the invention for simulating the mobility of a tooth advantageously consists of:
a bottom and a top bearing cup which are designed such that a substantially spherical region is spared,
wherein the top bearing cup comprises a substantially circular recess through which a tooth stump model is adapted to be inserted,
wherein the tooth stump model comprises a substantially spherical bearing portion at the one end thereof and defines a lengthy shaft at the other end thereof.

In the method according to the invention for simulating the tooth mobility by making use of a simulation device the following steps are performed:
fixing of a prefabricated dental prosthesis on a tooth stump model;
exerting a particular number of load and force alternation cycles on the dental prosthesis;
determining characteristic values by means of a testing machine (breaking load).

Advantageously, the top bearing cup has an annular recess at the upper end thereof into which a seal is adapted to be inserted such that the lengthy shaft of the tooth stump model does not get into contact with the top bearing cup. For fixing the seal, the top bearing cup is covered by a cover plate. The remaining gap between the lengthy shaft of the tooth stump model and the cover plate has a predetermined breadth and simulates the initial/desmodontal tooth mobility. This is to say, the tooth stump model is adapted to be moved across the entire breadth of the gap, attenuated by the seal, until it abuts on the edge of the cover plate.

The device according to the invention and the method according to the invention may be used both individually for every patient so as to test a particular prosthesis prior to the actual implantation and to make a reliable statement about the service life, for instance, or else as a test model for dentistry laboratories and dentistry manufacturers to make a basic statement with respect to feasibility, service life, etc. of particular materials or prosthesis techniques.

The present invention will be described in detail in the following Figures by means of a preferred embodiment. There show:

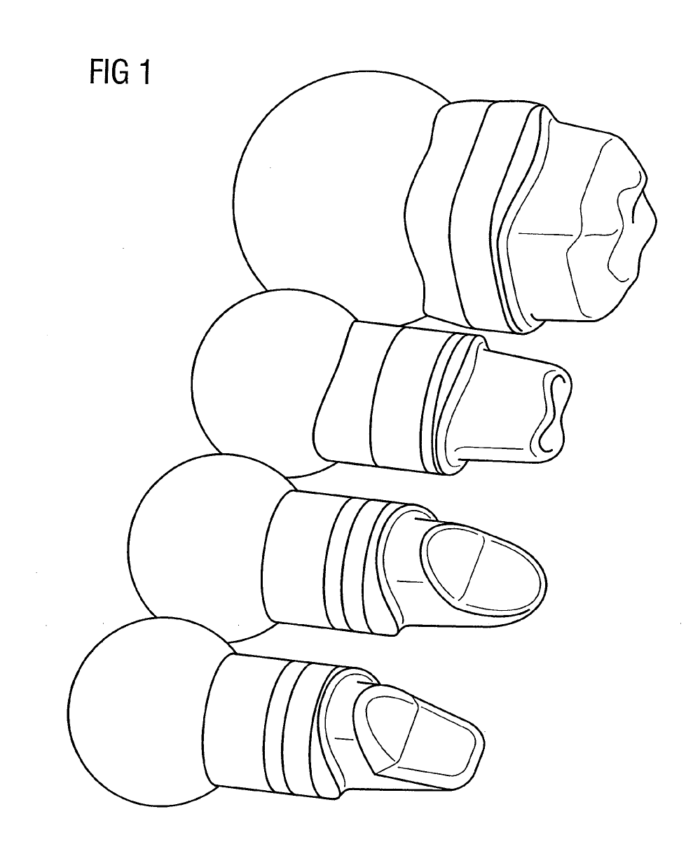

FIG. 1 an illustration of the simulation group: molar, premolar, corner tooth, anterior tooth;

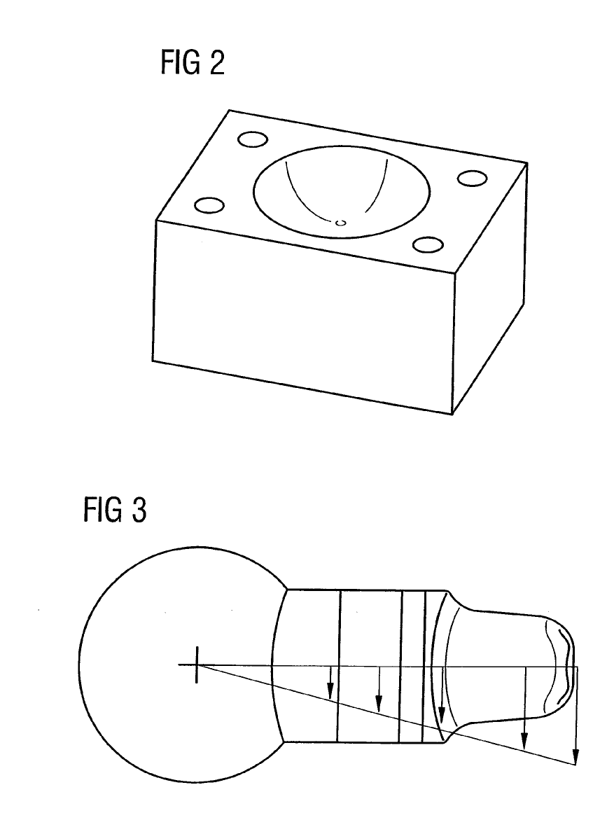

FIG. 2 a schematic illustration of a bottom bearing cup in accordance with the invention;

FIG. 3 a tooth stump model with lateral displacement indications in accordance with the invention;

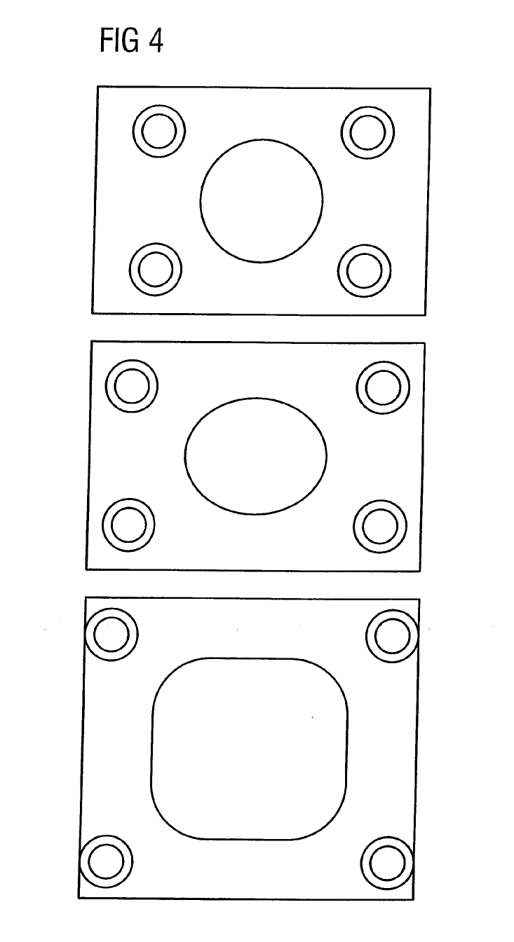

FIG. 4 cover plates in accordance with the invention;

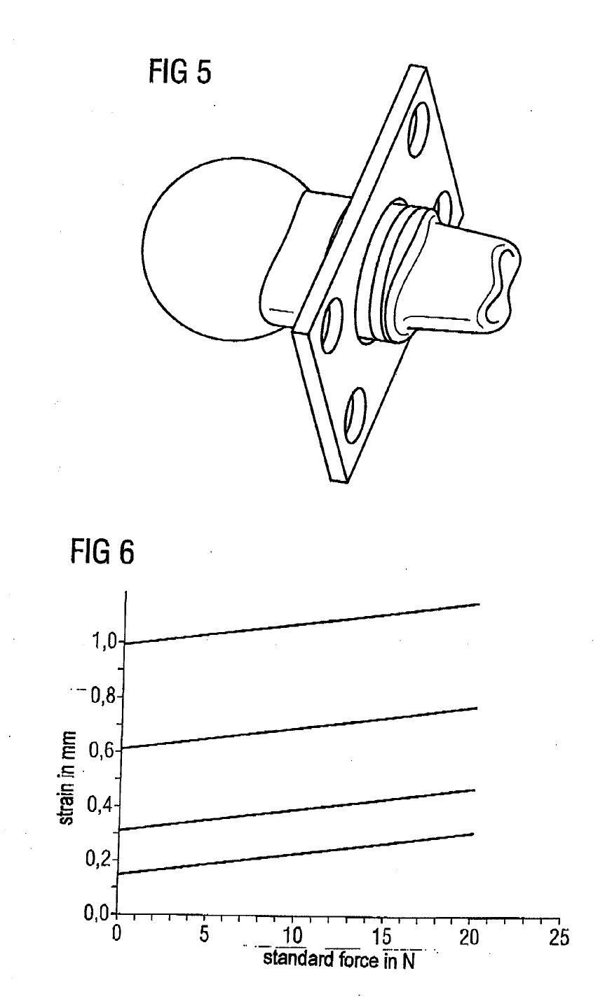

FIG. 5 a tooth stump model with cover plate in accordance with the invention;

FIG. 6 different mobility classes;

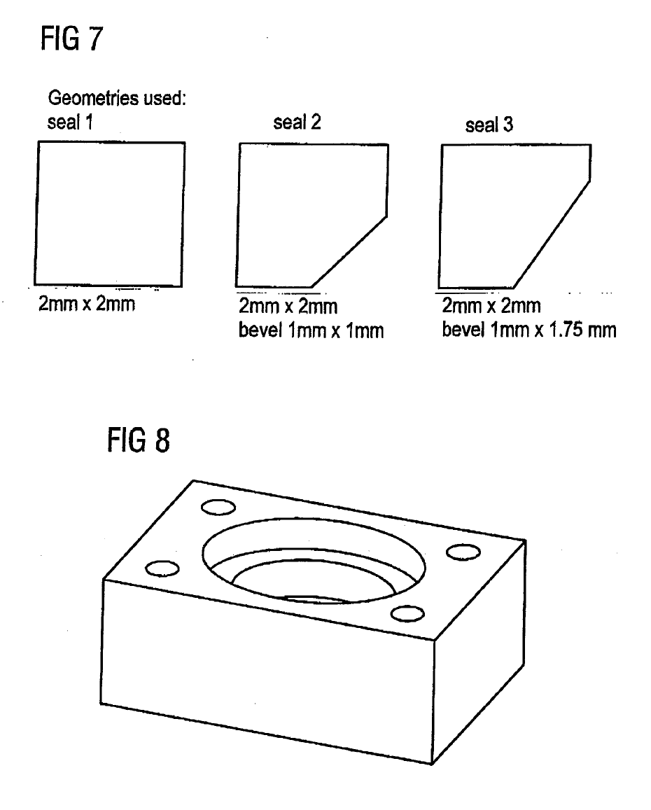

FIG. 7 seal geometries as used of the seals in accordance with the invention;

FIG. 8 a schematic illustration of a top bearing cup in accordance with the invention with a groove for a silicone insert;

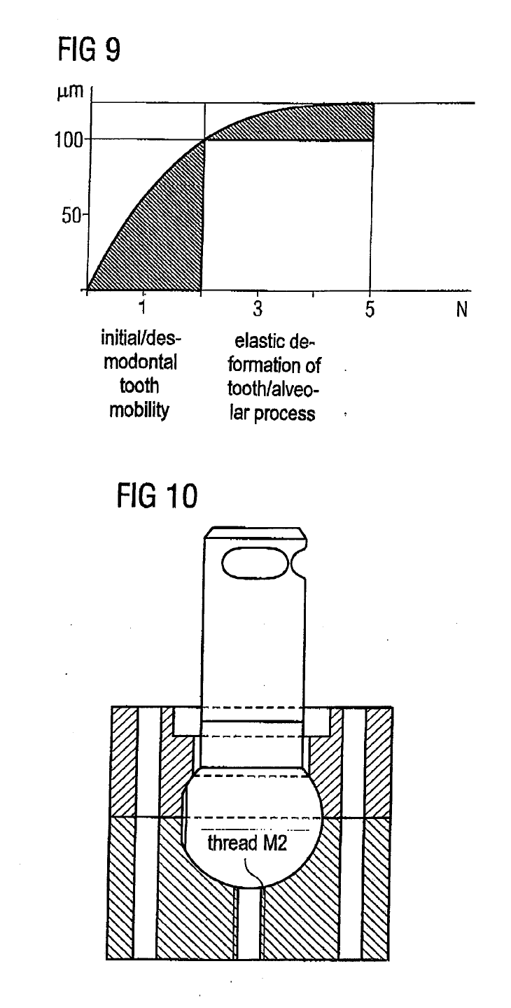

FIG. 9 a tooth mobility curve;

FIG. 10 an anti-twist protection in accordance with the invention.

In order to simulate a realistic tooth mobility for the respective group of teeth (anterior teeth and incisors, premolars and molars) it is expedient that the axial tooth mobility is modeled accordingly. During the simulation of the different groups of teeth they are, pursuant to FIG. 1, modeled by different cross-sectional shapes so as to realistically simulate the resistance typical of the group of teeth. In the case of anterior teeth and incisors the cross-section is designed circular, in the case of premolars the cross-section is designed elliptic, see FIG. 5, and in the case of molars the cross-section is designed substantially square with radii of curvature.

The mobility restriction in the horizontal plane is performed by the cover plates—see FIG. 4—, wherein, however, a twisting of the stump about its longitudinal axis cannot be restricted during the simulation of the anterior and corner teeth due to the circular cross-section of the root (rotational symmetry). To nevertheless prevent uncontrolled and thus undesired twisting of the stump, a flattening in accordance with the invention is applied at the ball of the tooth stump and of the bearing cups, see FIG. 10. Due to the differing distances of the flattenings from the center of rotation of the stump it is possible to define and determine the twisting path and the twisting angle.

In the case of a twisting of the stump beyond a particular angular dimension, the anti-twist protection becomes effective and a further twisting is prohibited. This safety mechanism is only required with the structure of anterior and corner teeth, not, however, with the premolar and molar structures. This is because an effective anti-twist protection exists in this case already due to the geometry of the stump—see FIG. 5—and due to the shape of the recess in the cover plate.

Nevertheless, the flattenings according to the invention may be applied at any stumps since they may serve as a lubricant reservoir. In the absence of scientific statements about the degree of the longitudinal twisting with teeth, an angle of twist of maximally 10 degrees was used with the embodiments according to the invention, wherein an angle of twist between 5 degrees and 10 degrees has turned out to be particularly advantageous and naturalistic.

For adjusting and adapting the tooth prosthesis it is expedient in accordance with the invention that the bottom bearing cup—see FIGS. 1 and 8—comprises fixing means for the tooth stump model. Fixing may, for instance, be performed by means of a screw that is screwed into the bottom bearing cup and penetrates to the spherical bearing area, in accordance with FIG. 10 this is implemented by a thread M2 in the bottom bearing cup.

In a preferred embodiment of the present invention the reproducible movement of the teeth is obtained in that the center of the spherical region—see FIG. 3—is positioned below the tooth stump model at ⅓ of the root length of apical. By the definition of the center of rotation by the bearing cups according to the invention—see FIGS. 1 and 8—in combination with the seal—see FIG. 7—the tooth stump model describes a substantially equal, reproducible trajectory. Since the tooth stump model possesses an exactly defined center of rotation, it is possible to calculate the line movement of every single point of the body with the assistance of the theorem of intersecting lines.

The formula for calculating mobility reads:

Gap=(stump diameter−plate inner diameter)/2

DM=distance of the mobility point to the center of rotation
DP=distance of the abutment point to the center of rotation

Mobility=(DM/DP)*gap*2

FIG. 6 illustrates the effect of a variation of the gap on the mobility of the simulation system. By the different mobility classes pursuant to FIG. 6 it is possible to adapt and scale the device according to the invention to the respective requirements of tooth prostheses by means of various cover plates pursuant to FIG. 4.

In the force range between 0 N to 2 N only the collagen fibers extend or are compressed, respectively. This range is also referred to as initial/desmodontal tooth mobility. This deformation is to be considered roughly linear. In order to simulate the elasticity of the fibers in the model, materials employed in dentistry with different coefficients of elasticity were examined as to their suitability. Due to its high resistance to aging, silicone cross linked by addition turned out to be advantageous for the seals in accordance with the invention. Apart from silicone cross linked by addition, other elastic substances such as, for instance, caoutchouc or appropriate plastics may also be used.

To be able to simulate different behaviors of deformation, the geometry of the seal may be varied, wherein three geometries have turned out to be advantageous. The basic shape of the preferred seals consists of a square with an edge length of 2 mm, and the individual variants differ by the degree of beveling:

Seal 1 has no beveling,
seal 2 has a beveling of 1*1 mm, and
seal 3 has a beveling of 1*1.75 mm.

In addition to these shapes, other shapes are also conceivable, for instance, O-rings or sealing rings with an elliptic cross-section.

These sealing lips are inserted into the top bearing cup and enable a linear elastic movement of the tooth. The linear elastic strain is followed by an elastic deformation of the periodontium which takes place in the range of 2 N to 5 N. To simulate this overlap of fiber strain and jaw strain, the top bearing cup is combined with the seal and the cover plate. The seal and the cover plate influence each other mutually. From a load of more than 5 N onward, as is illustrated in FIG. 9, only the strain of the alveolar bone occurs which is roughly linear.

In the device according to the invention the mobility of the tooth stump is adjusted by the distance of the cover plate to the center of rotation and the gap between the tooth stump and the cover plate. However, to enable a reproducibility of different test set-ups, a more exact classification of the stump mobilities is required.

The introduction of mobility classes is intended to improve the comparability of test runs. In the device according to the invention, four mobility classes (MK 0.15, MK 0.30, MK 060, MK 1.00) are used to cover substantially the entire specter of tooth mobility. Further, more delicate classifications of the mobility classes are also conceivable.

MK 0.15 means a mobility of 0.15 mm at a distance of 7 mm from the cover plate of the simulation model. This would roughly correspond to the mobility of the natural tooth. The number that follows MK indicates the mobility of the tooth in mm. Thus, it is possible to combine and compare different tooth mobilities in a simple manner.

The combination of the basic models of the groups of teeth, the cover plates, the sealing material, and the sealing shape in accordance with the invention permits a large number of combination possibilities and thus also a large number of different tooth mobility curves.

In accordance with a preferred embodiment of the present invention, the following combinations are expedient for the mobility classes due to an analysis of the tooth mobility curves:

### Possibilities of Combination

### Model Anterior/Corner

MK 0.15; cover plate 0.15; seal 1
MK 0.30; cover plate 0.30; seal 1
MK 0.60; cover plate 0.60; seal 1
MK 1.00; cover plate 1.00: seal 1

### Model Premolar

MK 0.15; cover plate 0.15; seal 3
MK 0.30; cover plate 0.30; seal 3
MK 0.60; cover plate 0.60; seal 2
MK 1.00; cover plate 1.00; seal 2

### Model Molar

MK 0.15; cover plate 0.15; seal 1
MK 0.30; cover plate 0.30; seal 1
MK 0.60; cover plate 0.60; seal 1
MK 1.00; cover plate 1.00; seal 2

The afore-described combinations of base bodies pursuant to group of teeth, abutment plate, sealing material, and sealing shape describe a particularly advantageous solution for the tooth mobility simulation according to the invention.

In a preferred embodiment of the present invention, the following stump geometries were determined empirically for the three basic types (anterior, premolar, molar):

### Anterior/Corner:

diameter: 7 mm
root length: 13 mm
total length: 22 mm
crown length: 9 mm

### Premolar:

diameter_{—}1: 6.5 mm
diameter_{—}2: 7 mm
root length: 14 mm
total length: 22 mm
crown length: 9 mm

### Molar:

breadth_{—}1: 10 mm
breadth_{—}2: 11 mm
root length: 13.5 mm
total length: 20.5 mm
crown length: 7 mm

The actual tooth geometries comprise a very large scattering of the individual tooth values, the stump geometries determined here are thus only coarse approximations; nevertheless, these values have turned out sufficient for a realistic tooth mobility simulation.

### Mobility of Degree 4

To simulate a mobility of degree 4, i.e. an additional displacement of the stump in axial direction, a cover plate of variable strength is inserted between the top and the bottom bearing cups in the device according to the invention.

To this end, after the finishing of the stump processing, the retaining mechanism is loosened and the retaining screw is removed. Then, a small amount of a soft plastic material (e.g. Adisil blue) is applied on the retaining screw. Subsequently, the retaining screw is screwed in again. The screw, however, must not impair the horizontal mobility of the tooth stump model. After the tightening of the retaining screw the plastic material pushes the stump upwards. If the stump is now strained axially, the plastic material is compressed again and an axial shifting of the stump occurs before the stump is able to tip laterally.

To design the device according to the invention as close to reality as possible, it is expedient that the materials used have properties that resemble those of jaw bones and teeth. The following characteristic values of the material have turned out to be advantageous:
Dentin coefficient of elasticity: 18300 MPa
Compact bone (bone tissue) coefficient of elasticity: 15000 MPa
Cancellous bone coefficient of elasticity: 1370 MPa
Periodontal tissue coefficient of elasticity: 69 MPa

While a material with characteristic values similar to that of compact bone is suitable for the bearing cups and cover plates according to the invention, it is expedient if the stump consists of a material with characteristic values similar to that of dentin. For the supports, reinforced PUR as well as fiber-reinforced high performance polymer (C-Temp, coefficient of elasticity 22000 MPa)

1. An apparatus for simulating the mobility of a tooth, comprising:
a bottom and a top bearing cup which are designed such that a substantially spherical area is spared;
wherein the top bearing cup comprises a substantially circular recess through which a tooth stump model is adapted to be inserted; and
wherein the tooth stump model comprises a substantially spherical bearing portion at the one end thereof and defines a lengthy shaft at the other end thereof.

2. An apparatus according to claim 1, wherein the top bearing cup comprises a ring-shaped recess at the upper end thereof into which a seal is adapted to be inserted such that the lengthy shaft of the tooth stump model does not get into contact with the top bearing cup.

3. An apparatus according to claim 2, wherein the top bearing cup and the seal are adapted to be covered by a cover plate.

4. An apparatus according to claim 3, wherein the cover plate is designed such that a gap of predetermined breadth is formed between the lengthy shaft of the tooth stump model and the cover plate.

5. An apparatus according to claim 4, wherein the spherical bearing portion and the bottom and top bearing cups comprise a flattening in an appropriate place for anti-twist protection.

6. An apparatus according to claim 5, wherein the bottom bearing cup comprises fixing means for the tooth stump model.

7. An apparatus according to claim 6, wherein the cross-section of the shaft of the tooth stump model is designed to be one of (a) circular, (b) elliptic or (c) substantially square with radii of curvature.

8. A method for simulating the tooth mobility by making use of a simulation device, comprising the following steps:
fixing of a prefabricated dental prosthesis on a tooth stump model;
exerting a particular number of load and force alternation cycles on the dental prosthesis; and
determining characteristic values by means of a testing machine.

9. The method for simulating the tooth mobility according to claim 8, wherein the simulation device comprises:
a bottom and a top bearing cup which are designed such that a substantially spherical area is spared;
wherein the top bearing cup comprises a substantially circular recess through which a tooth stump model is adapted to be inserted; and
wherein the tooth stump model comprises a substantially spherical bearing portion at the one end thereof and defines a lengthy shaft at the other end thereof.

10. An apparatus according to claim 1, wherein the spherical bearing portion and the bottom and top bearing cups comprise a flattening in an appropriate place for anti-twist protection.

11. An apparatus according to claim 1, wherein the bottom bearing cup comprises fixing means for the tooth stump model.

12. An apparatus according to claim 1, wherein the cross-section of the shaft of the tooth stump model is designed to be one of (a) circular, (b) elliptic or (c) substantially square with radii of curvature.
